(19) United States
(12) Patent Application Publication
(10) Pub. No.: US 2023/0214435 A1
(43) Pub. Date: Jul. 6, 2023

(54) METHODS AND APPARATUS FOR PERSISTENT SEARCH WITHIN A BROWSER

(71) Applicant: Google LLC, Mountain View, CA (US)

(72) Inventors: Frederico Barros Parente de Mello, Cambridge (CA); Calder Kitagawa, Durham, NC (US); Yana Yushkina, Seattle, WA (US); John Oliver Por, San Francisco, CA (US); Mehran Mahmoudi, Toronto (CA); Yashar Dabiran, Kitchener, CA (US); Thomas Lukaszewicz, Mountain View, CA (US); Frank Goodman, San Francisco, CA (US)

(21) Appl. No.: 18/148,844

(22) Filed: Dec. 30, 2022

Related U.S. Application Data
(60) Provisional application No. 63/266,295, filed on Dec. 31, 2021.
(60) Provisional application No. 63/266,296, filed on Dec. 31, 2021.

(51) Int. Cl. G06F 16/9538; G06F 16/954; G06F 3/0482; G06F 3/0483; G06F 3/0485

(52) U.S. Cl. CPC G06F 16/9538; G06F 16/954; G06F 3/0482; G06F 3/0483; G06F 3/0485; G06F 2203/04803

(57) ABSTRACT

In one general aspect, a method can include receiving a search query and causing display of a first search result and a second search result within a display area of a browser in response to the search query. In response to a selection of the first search result, the method can include causing display of a webpage within a display area of the browser, and causing display of a first search result indicator corresponding with the first search result and a second search result indicator corresponding with the second search result in a search result area outside of the display area where the search result area is within the browser. In some implementations, the method includes causing display of the search result area in response to interaction with the display of the webpage in the display area.

### RELATED APPLICATION

This application is a non-provisional of, and claims priority to, U.S. Provisional Application No. 63/266,295, filed Dec. 31, 2021, and to U.S. Provisional Application No. 63/266,296, filed Dec. 31, 2021, the disclosures of which are incorporated herein by reference.

### BACKGROUND

A web browser can be used to display content that is searched via a search engine. Content can be displayed within the web browser in response to selection of one or more of the search results by a user.

### SUMMARY

Implementations relate to providing persistent search results within a browser. In particular, implementations relate to rendering a search result area concurrently with a display area (a main content window). The search result area displays at least two search results, where a search result represents a resource that is responsive to a query. The display area displays the content associated with a webpage (resource) that corresponds to one of the two search results. In some implementations, the search results may be represented in the search result area by search result indicators, which are actionable user interface elements. Each search result indicator is associated with a resource determined to be responsive to the query. This resource is referred to as the search result target. Interaction with a search result indicator causes the browser to display the resource associated with the search result (the search result target) in the display area without closing the search result area. In some implementations the search result area represents search results for a portion of a search result page (i.e., selected search results from the search result page). Rendering of the search result area can be triggered by selection of a search result in a search result page. Rendering of the search result area can be triggered by interaction with a webpage displayed in response to selection of a search result in a search result page. The interaction can include selecting a “back” action when viewing a target of a search result. The interaction can include a scrolling pattern detected during display of the target of a search result.

In one general aspect, a method can include receiving a search query and causing display of a first search result and a second search result within a display area of a browser in response to the search query. In response to a selection of the first search result, the method can include causing display of a webpage identified by the first search result within the display area of the browser, and causing display of a first search result indicator corresponding with the first search result and a second search result indicator corresponding with the second search result in a search result area outside of the display area, where the search result area is within the browser.

In one general aspect, a method can include receiving a search query and causing display of a first search result and a second search result within a display area of a browser in response to the search query. In response to a selection of the first search result, the method can include causing display of a webpage identified by the first search result within the display area of the browser, and in response to receiving an interaction with the display of the webpage, causing display of a first search result indicator corresponding with the first search result and a second search result indicator corresponding with the second search result in a search result area outside of the display area, where the search result area is still within the browser.

### BRIEF DESCRIPTION OF THE DRAWINGS

FIG. 1A is a diagram that illustrates search results displayed within a display area of a browser executing on a device with a screen of limited size.

FIG. 1B is a diagram that illustrates a search result area triggered for display within a browser.

FIGS. 1C and 1D illustrate content of webpages rendered in a navigation area within a browser.

FIGS. 2A through 2C are diagrams that illustrate variations of search result indicators displayed in the search result area.

FIGS. 3A through 3C are diagrams that illustrate a search result area triggered for display in response to one or more interactions with a webpage.

FIGS. 4A through 4D illustrate rendering of a search result area after more than one search result is selected.

FIGS. 5A and 5B illustrate closing of a search result area in response to link interaction within a webpage.

FIG. 6 illustrates a security feature associated with the implementations described herein.

FIG. 7A is a diagram that illustrates search results displayed within a display area of a browser executing on a device with a larger screen.

FIG. 7B is a diagram that illustrates a search result target displayed within a display area of a browser.

FIGS. 7C and 7D are diagrams illustrating a search result area triggered for display within a browser.

FIG. 8 is a diagram that illustrates a computing system and search server for implementing the concepts described herein.

FIG. 9 is a flowchart illustrating an example process for persisting a search result page in a search result area of a browser, according to an implementation.

FIGS. 10 is a flowchart illustrating an example process for persisting a search result page in a search result area of a browser, according to an implementation.

FIG. 11 shows an example of a generic computer device and a generic mobile computer device, which may be used with the techniques described herein.

### DETAILED DESCRIPTION

This disclosure is related to navigation of content associated with search results retrieved in response to a search query. The search results can be displayed within a search result area of the browser, or in a search result area of another browser, so that the content of a webpage associated with a search result is maintained (e.g., persists) in the browser while the search results are displayed. Likewise, the search results are maintained (e.g., persist) while content of the resources associated with the search results are maintained. At least one of the search results in the search result area can be selected, and content associated with the selected search result can be displayed in the display area. Thus, implementations enable navigation of webpages represented by the search results with fewer user interactions. In some implementations, the content associated with the search results can replace content of the webpage within the browser. In some implementations, the content associated with the search results can be displayed within another browser. The search results can continue to be displayed (e.g., can be maintained, or can persist) even as the content of the search results are navigated and/or displayed. The browser can be referred to as a browser window when associated with a window of an operating system (OS).

A technical problem associated with searches, such as Internet-based searching, is that several interactions are needed to navigate to resources represented in the search result page. As is known, a search result page is generated by a search engine in response to a query. The search result page includes search results and can include other content, such as ads, knowledge panels, short answers, other types of rich results, links to limit the search to a particular resource type (e.g., images, travel, shopping, news, videos, etc.). Each search result corresponds to a resource available via a network, e.g., via a URL/URI/etc. The resources were determined to be responsive to the query by the search engine. The search result includes a link to its corresponding resource. The search result can include additional information, such as a title, a snippet (text obtained from the content of the resource), an image associated with the resource, etc., or other information relevant to the resource and/or the query, as determined by the search engine. The browser displays the search result page in the display area. With a conventional browser, when a user interacts with (selects) a search result (or in other words, selects the link to the resource, the link being included in the search result), the browser requests the content of the resource associated with the link and replaces the search result page in the display area with the content of the resource. To return to the search result page to view a different resource, the user must resubmit the query or must select a browser interface control configured to return the user to the previous resource (e.g., a back control). Selection of this back control causes the browser to again render the search result page in the display area, where the user can select a different link to a different resource, which causes the browser to fetch and render the content of the different resource. This back-and-forth between the search result page and the resources represented in the search result page is inefficient for the computing device and the user. For example, the computing device expends resources (battery, processing power, and potentially network bandwidth for re-fetching) to re-render the search result page several times as the user navigates to the resources represented by the search results. In addition, the user must perform an extra interaction with the browser to accomplish the navigation because the search results are not maintained during navigation of the content.

At least one technical solution to the technical problems described above is that search results can be maintained (persist) within a search result area of the browser while the user navigates to resources represented by the search result. Thus, the content of the resource is maintained (e.g., persists) in the browser in a separate display area while the search results are displayed. At least one technical effect of this technical solution is that the computing device on which the browser executes performs fewer renderings of the search results. Search results within a search result area and webpage content within a display area can be simultaneously displayed within the browser (e.g., within a tab of the browser). This technical solution has the technical effect of reducing the number of interactions a user has with the browser to navigate the different resources represented by the search results. Put another way, because search results for a query persist in the search result area, interactions with the back control of a browser are eliminated.

In some implementations, a search result area can be integrated as part of the browser so that the search result area may not be spoofed (e.g., imitated) by a third party or the owner of the webpage content. This can be implemented as a security feature so that a user can distinguish legitimate search results provided by a search query from search results that can be inserted by a third party or by the provider of a webpage or other resource. Accordingly, the technical problem of spoofing search results can be obviated by the technical solution of integrating a search result area within the browser as described above. The technical effect of integration of a search result area within a browser is that spoofing can be prevented.

As mentioned above, in some implementations, search results can continue to be displayed (e.g., can be maintained, or can persist) in a search result area even as the content of resources represented by the search results are navigated to and displayed. The content associated with the resources represented by the search results can be displayed within the display area simultaneously within the browser (e.g., within a tab of the browser) with the search result area. This can be achieved even if only a limited available screen space is available by, e.g., scaling the resolution of the content to be displayed in the display area in case the size of the display area is decreased in order to display the display area and the search result area together within the browser on the limited available screen space. Accordingly, the technical problem of being unable to simultaneously navigate content associated with search results while viewing the search results in a search result area is solved by the technical solution and technical effect described above.

The implementations described herein enable improved guided human-machine interactions for viewing webpages and other resources on the one side and displaying search results on the other side. The viewing of results of a query and the viewing of webpages represented by the results are done simultaneously by using one user interface only. This saves processing resources and potentially bandwidth (by avoiding additional fetching of a search result page). This also results in fewer interactions of the user with the user interface as the user may easily switch between different resources from the results and view the content of the resource at the same time in the same interface.

The browsers described herein can be executed within a computing device. For example, the browsers can be executed within a laptop device. In some implementations, the browsers can be executed within a mobile device. or on any other device with limited available screen space. Although many of the implementations shown and described herein are shown in portrait mode, any of the implementations described herein can be rendered in a landscape mode. Likewise, implementations described herein in landscape mode can be rendered in a portrait mode.

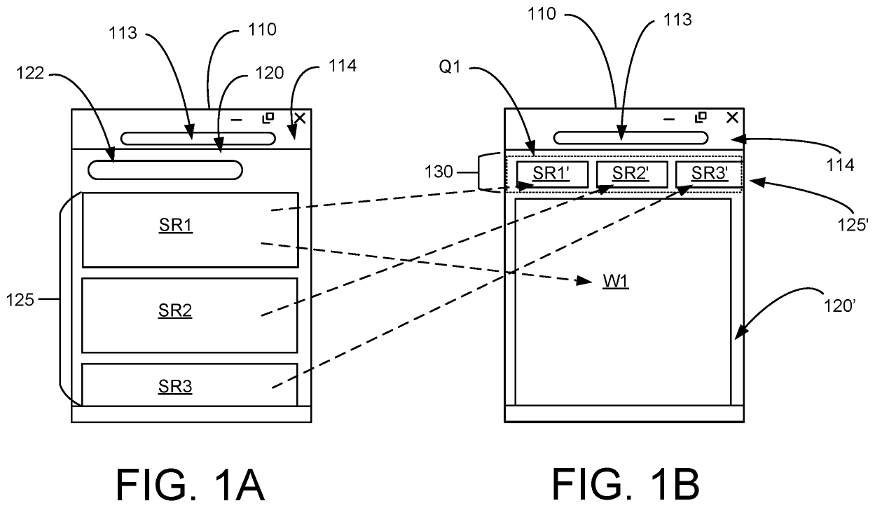

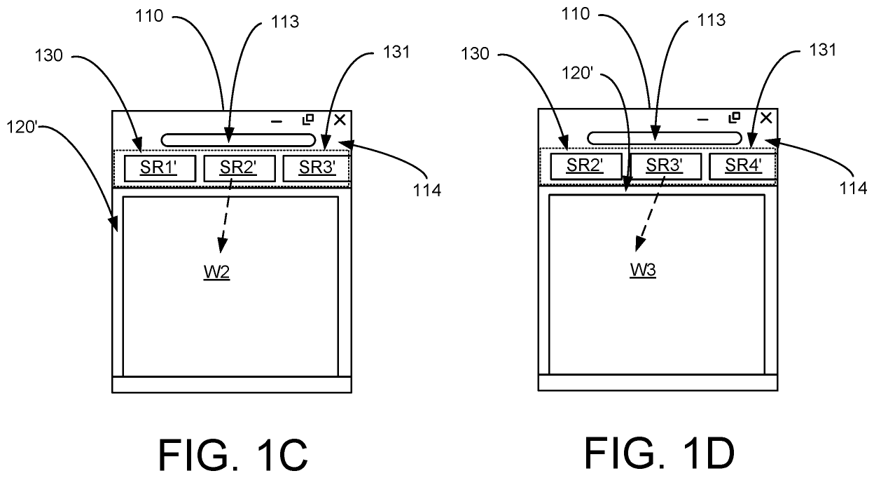

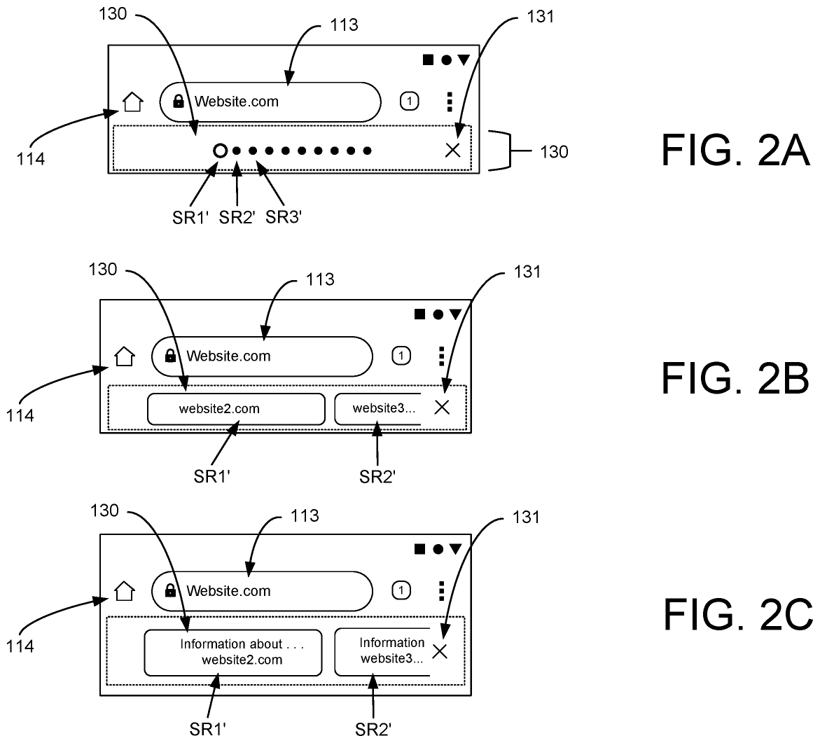

FIG. 1A is a diagram that illustrates search results SR1 through SR3 (collectively can be referred to as search results 125) displayed within a display area 120 of a browser 110. In some implementations, the display area 120 can be within a tab of the browser 110. The search results 125 can be triggered for display in response to a search query. In some implementations, the display area 120 can include an indication of the query 122. The indication of the query 122 includes the content (e.g., text/image) used as the query. In some implementations, the indication of the query 122 is a text entry area where the user can provide a new query and trigger a new search. The search results 125 can be included in a search result page. A search result page is a webpage generated by a search engine of a search server in response to a query and typically includes one or more search results. As is understood, the search results, e.g., SR1 through SR3, are each associated with a respective resource, e.g., webpage, file, etc., available over a network. The search query, to which the search results 125 are responsive, can be triggered by a user of, for example, a computing device via a text search, an image search, and/or so forth. A user interface for triggering the search query is not illustrated herein. Although not illustrated in FIG. 1A, there may be additional search results identifying resources responsive to the query included in the search results 125. These may be viewed, for example, by scrolling.

In some implementations, one or more of the search results 125 can include text. In some implementations, one or more of the search results 125 can include images. One or more of the search results 125 include a respective link, i.e., a link to a resource available via a network such as the Internet. The resource is a source of content (e.g., images, webpages, documents, etc.). Any search result that includes a link is actionable. In other words, a search result with a link can be interacted with, e.g., via selection of the link. The interaction with a link of a search result of search results 125 causes the browser to fetch the content of the resource associated with the link. Because of this, a search result can be referred to as selectable and interaction with a search result is understood to refer to interaction with (e.g., selection of) the link associated with the search result.

FIG. 1B is a diagram that illustrates a search result area 130 (shown by a dashed box) triggered for display within the browser 110. In some implementations, the search result area 130 can be triggered in response to at least one of the search results 125 being selected (e.g., interacted with). For example, in the example of FIG. 1B, search result SR1 in FIG. 1A has been selected. Thus, in response to interaction with (e.g., the selection of) search result SR1 in FIG. 1A, the webpage W1 is displayed within the display area 120′ in FIG. 1B. The webpage W1 is the resource associated with the link of SR1 in this example. Also, in response to the selection of the search result SR1 in FIG. 1A, the search result area 130 is rendered within the browser 110 in FIG. 1B. Accordingly, in response to the selection of search result SR1 in FIG. 1A, as illustrated in FIG. 1B, both the webpage W1 is displayed within the display area 120′ and the search result area 130 is rendered within the browser 110. Also, in response to the selection of search result SR1 in FIG. 1A, as illustrated in FIG. 1B, both the webpage W1 is displayed within the display area 120′ and the search result indicator SRI′ is displayed within the search result area 130 within the browser 110.

Consistent with the description above, rendering of the search result area 130 in FIG. 1B is triggered in response to an interaction with (e.g., selection of) one or more of the search results 125 in FIG. 1A. Rendering of the search result area 130 in FIG. 1B can be triggered in response to an interaction with any of the search results 125 in FIG. 1A. For example, rendering of the search result area 130 in FIG. 1B can be triggered in response to selection of the search result SR2 in FIG. 1A.

In some implementations, an interaction can include a selection. In some implementations, an interaction and/or selection (or an indication thereof) can be used to trigger an action or result. A user interface element that triggers an action in response to interaction with the element is referred to as an actionable element. The search results 125 are examples of actionable elements.

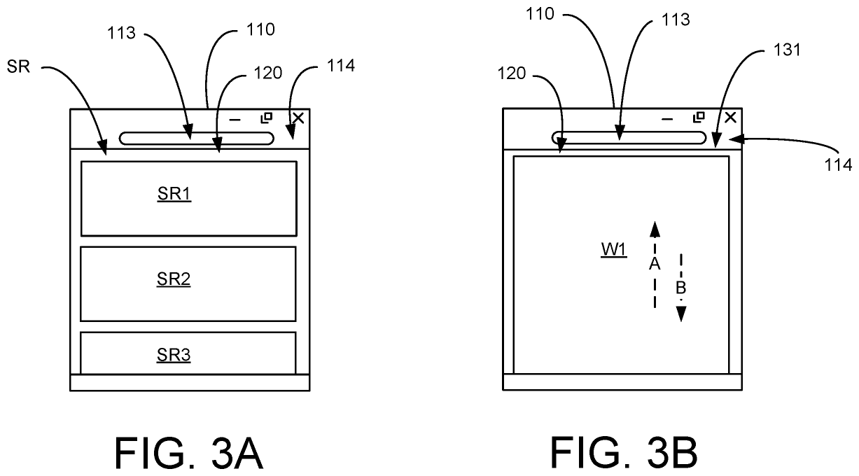

As shown in FIG. 1B, in some implementations, the search results SRI through SR3 of FIG. 1A can be replaced with search result indicators SRI′ through SR3. In some implementations, the browser can use a template or a DOM model to identify search results 125 in the search result page. The search result page can be a cached page or can be re-fetched from the search server. The search result indicators 125′ each correspond to a respective search result of the search results 125. The search result indicators 125′ are also actionable elements. A search result indicator performs the same action when interacted with that its corresponding search result performs. In other words, selection of search result indicator SR1′ causes display of webpage W1, just as selection of search result SR1 causes display of webpage W1. However, a search result indicator occupies much less area within the browser than its corresponding search result. In other words, a search result indicator has a smaller footprint than the search result it corresponds to. The smaller footprint enables the browser to display the search results in the search result area 130 concurrently with the webpage W1 in the display area 120. The smaller footprint can be important for a computing device with a limited screen size, such as a mobile phone, smart watch, smart glasses, tablet, etc. Example search result indicators 125′ are discussed in more detail with respect to FIGS. 2A-2C.

In the example of FIG. 1B, the search results 125 are displayed within the search result area 130 as search result indicators SR1′ through SR3′ (collectively referred to as search result indicators 125′). The search result indicators SR1′ through SR3′ correspond, respectively, with the search results SRI through SR3. The user can use the search results indicators SRI′ through SR3′ to navigate to resources associated with the search results SR1 through SR3. In other words, the search result indicators SR1′ through SR3′ can be, or can include, for example, links associated with search results SRI through SR3.

In some implementations, the search results SRI through SR3 (and search result indicators SRI′ through SR3′) may be a subset of search results surfaced in response to a search query. In some implementations, the search SRI through SR3 (and search result indicators SRI′ through SR3′) can be a rank-ordered (e.g., highest ranked) subset of search results surfaced in response to a search query. In some implementations, one or more of the search results SR1 through SR3 can be prioritized so that the most relevant search results (or a subset thereof) are rendered within the search result area 130.

Although not shown in FIG. 1B, in some implementations, the search result indicator SR1′ may not be displayed within the search result area 130 because the webpage W1 corresponding to the search result SR1 is displayed. Accordingly, at least the search result associated with the resource (e.g., a webpage) already displayed in the display area 120′ may not be included in the search result area 130. This enables other search result indicators to be visible in the search result area 130, especially where a size of the screen is limited.

In some implementations, although not shown in FIG. 1B, additional search results 125 accessible via scrolling (or otherwise navigating through the display area 120) in FIG. 1A can correspond to additional search result indicators 125′ accessible via scrolling in FIG. 1B. For example, in some implementations, the additional search results can be viewed by scrolling left and right within the search result area 130.

As shown in FIGS. 1A through 1D, the browser includes an address bar area 114. An address of the webpage W1 can be illustrated in the address bar area 114 (e.g., input address area 113). Other controls, icons, and/or so forth can be included in the address bar area 114. The address bar area 114 can be controlled by and/or associated with the browser 110 (e.g., the browser application). Because the address bar area 114 is controlled by the browser 110, the webpage W1 and/or a provider of the webpage W1 does not have access to content displayed in the address bar area 114 or triggering actions provided by actionable elements of the address bar area 114.

Although not shown in FIG. 1B, in some implementations, the search result area 130 is separated from the address bar area 114 by a visible separation line between the address bar area and the search result area 130. The line can be eliminated (e.g., omitted), for security purposes. When provided, this is a line that a third party (e.g., provider of the webpage W1) may not remove (e.g., paint over, scrub out). In other words, when provided, this is a line that is controlled (e.g., provided by, eliminated by) the browser 110 (e.g., browser application), similar to the address bar area 114.

As shown in FIG. 1B, in response to the search result area 130 being rendered in response to the search query, the size (e.g., an area) of the display area 120 (shown in FIG. 1A) is decreased to a size of the display area 120′. In other words, the display area 120 (shown in FIG. 1A) is decreased in size in response to the search result area 130 being displayed to accommodate the search result area 130. In some implementations, the webpage W1 can be modified (e.g., scaled) in layout to fit (e.g., fit for display) into the display area 120′. According to an implementation, scaling of the webpage W1 is achieved by displaying the webpage W1 in lower resolution so that the webpage W1 is displayed without decreasing the visible area of the webpage W1 within the decreased display area 120′. This implementation has the technical effect that in addition to the webpage W1 as displayed in the display area 120′ the search results can be displayed in the search result area 130 on a, e.g., limited available screen space. In some implementations, the search result area 130 can overlap with the webpage W1 without modifying the scale of the webpage Wl. Put another way, a visible portion of W1 may decrease because of the decreased visible area of the display area 120′ but a scale of the webpage W1 does not change. In some implementations, the display area 120 shown in FIG. 1A can be divided into the display area 120′ and the search result area 130 as shown in FIG. 1B. The combined areas of the display area 120′ and the search result area 130 shown in FIG. 1B can be the same as the area of the display area 120 as shown in FIG. 1A. In some implementations, the combined areas of the display area 120′ and the search result area 130 can be different from (e.g., smaller than, larger than) the area of the display area 120.

FIG. 1C illustrates content of a webpage W2 rendered in display area 120′ within the browser 110. The content of the webpage W2 is rendered in the display area 120′ in response to an interaction (e.g., a user interaction) with the search result indicator SR2′ in the search result area 130 of FIG. 1B. The webpage W2 displayed in the display area 120′, in this implementation, replaces the webpage W1 displayed in the display area 120′.

The combination of concurrent display of the search result area 130 and the display area 120′ can be used to consume (e.g., explore) the search results in the search result area 130 with minimal user interactions and reduced computing resource usage. For example, in response to a first search result indicator being selected from the search result area 130, first content can be rendered in the display area 120′. In response to a second search result indicator being selected from the search result area 130, second content can be rendered in the display area 120′, replacing the first content. This improved search result navigation can occur while the search results (e.g., search result indicator SR1′) are maintained within the search result area 130.

FIG. 1D illustrates content of a webpage W3 rendered in a display area 120′ within the browser 110. The content of the webpage W3 is rendered in the display area 120′ in response to an interaction (e.g., a user interaction) with the search result indicator SR3′ in the search result area 130. The webpage W3 displayed in the display area 120′, in this implementation, replaces the webpage W2 displayed in the display area 120′ of FIG. 1C. As shown in FIG. 1D, in this example, the positions of the search result indicators are shifted so that the search result indicator SR3′ corresponding with the webpage W3 is more centered within the search result area 130. Also, in FIG. 1D, search result indicator SR4′ is displayed because search result indicator SR3′ has shifted position in the search result area 130. This shift of position may result in SR1′ not being rendered in the search result area 130. In other words, as a result of the interaction of SR3′ of FIG. 1C, the browser may scroll SR3′ to a position of prominence (centered in the display), causing SR1′ to scroll off the visible portion of the screen and causing SR4′ to scroll onto the visible portion of the screen.

Further to the implementation shown in FIGS. 1A through 1D, in some implementations, a new resource location (web address) or search can be input into input address area 113 of the address bar area 114 after the search result area 130 and the display area 120′ are defined. In response to the input to the input address area 113, a different webpage (not shown) can replace the webpage W2 (or other content) in the display area 120′, while maintaining the search result indicators SR′ in the search result area 130. In other words, the search result indicators SR′ can be maintained even while navigating within the display area 120′ and using a different web address in the address bar area 114 of the browser 110. In some implementations, in response to the input to the input address area 113, the browser may remove the search result area 130, returning the display area 120′ to display area 120. The content of the resource corresponding to the input to the input address area 113 may be displayed in the display area 120. Thus, in some implementations, input to the input address area 113 may cause removal of the search result area 130.

In some implementations, a user interface element (e.g., a back control, such as a back button, a back arrow) can be used to remove (e.g., clear, navigate away from) content rendered in the display area 120′ (e.g., the webpage W2). In other words, user interaction with a back control can trigger removal of the search result area 130. In some implementations, removal of (e.g., clearing) the search result area 130 automatically returns the display area 120′ to display area 120. In some implementations, removal of the search result area 130 does not occur until the prior back action returns the user to the search result page. Put another way, using the example of FIG. 1D, the first interaction with the back control may cause generation of the browser interface illustrated in FIG. 1C, the next interaction with the back control may cause generation of the browser interface illustrated in FIG. 1B, and the next interaction with the back control may cause generation of the browser interface to the interface illustrated in FIG. 1A, removing the search result area 130 and returning the display area 120′ to display area 120.

Although discussed in the context of webpages W1 through W3, in some implementations, the content rendered in the display area 120′ may not be a webpage. As discussed herein, the content may be associated with any resource accessible via a network. Thus, in some implementations, the content displayed in the display area 120′ can be in an image, a link, a video, text, and/or so forth.

In some implementations, although not shown, the search results 125 can be bookmarked or associated with a bookmark of the browser 110. In some implementations a finite number of the search results (e.g., top 5) may be bookmarked.

FIGS. 2A through 2C are diagrams that illustrate variations of the search result indicators 125′ displayed in the search result area 130. As illustrated in FIGS. 2A through 2C, the search result area 130 can include an affordance, or actionable control 131 (a selectable “X” icon) that can be used to close the search result area 130. FIG. 2A illustrates a compact mode, FIG. 2B illustrates a normal mode, and FIG. 2C illustrates an information mode.

As shown in FIG. 2A, the search result area 130 illustrates at least search result indicators SR1′ through SR3′. The search result indicators SR1′ through SR3′ are represented by icons. In the example of FIG. 2A, the icons are circles, but any icons can be used. The open circle represents the current search result being selected. Put another way, the open circle represents the search result that corresponds to the content currently displayed in the display area 120′. The closed circles represent search results that are not selected, or in other words search results not associated with the content currently displayed in the display area 120′.

As shown in FIG. 2B, the search result area 130 illustrates textual search result indicators SR1′ and SR2′. In the example of FIG. 2B the text for a search result indicator represents minimal text used to identify the resource associated with the search result. In the example of FIG. 2B, the search result indicators SR1′ and SR2′ include a portion of the domain of the website addresses (e.g., a portion of the uniform resource locators (URLs)). The website addresses represent identifiers of the resources associated with the search result indicators SRI′ and SR2′. The portion of the domain used as text for the search result indicators may be sufficient to differentiate SR1 from SR2. Some implementations may use other text from the search results, e.g., document title, an image thumbnail, etc. to identify the resource corresponding to the search result.

As shown in FIG. 2C, the search result area 130 illustrates informational search result indicators SR1′ and SR2′. The informational textual search result indicators can include the textual search result indicators (or image thumbnail) plus some additional information about the resource. In the example of FIG. 2C, the search result indicators SR1′ and SR2′ include information about websites as well as website addresses.

The search result indicators in the search result area 130 in FIG. 2A are compact as compared with the search result indicators shown in FIGS. 2B and 2C. The search result indicators in the search result area 130 in FIG. 2C are in an information dense form.

Although not shown, the search result area 130 may be switched between one or more of the modes shown in FIGS. 2A through 2C. For example, upon selection of the search result area 130 in the compact mode shown in FIG. 2A, the search result area 130 can be transformed to, for example, the search result area 130 in the normal mode. Selection of the search result area 130 in the compact mode can demonstrate interest in more information that is illustrated in the normal mode.

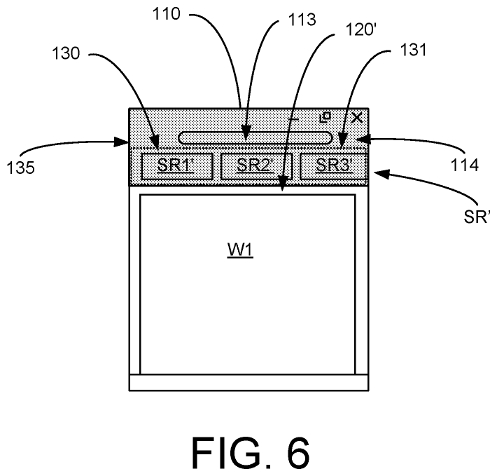

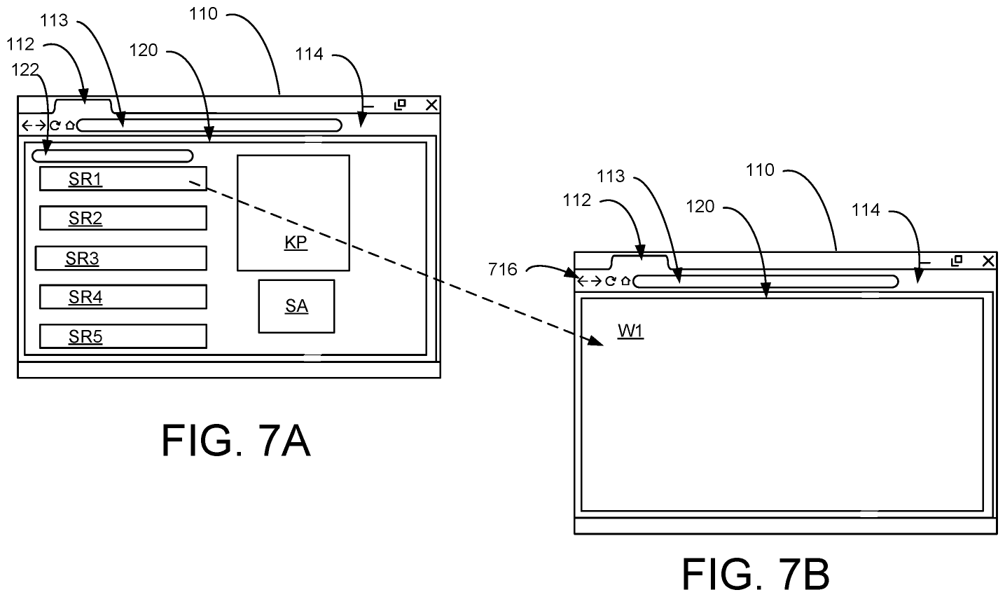

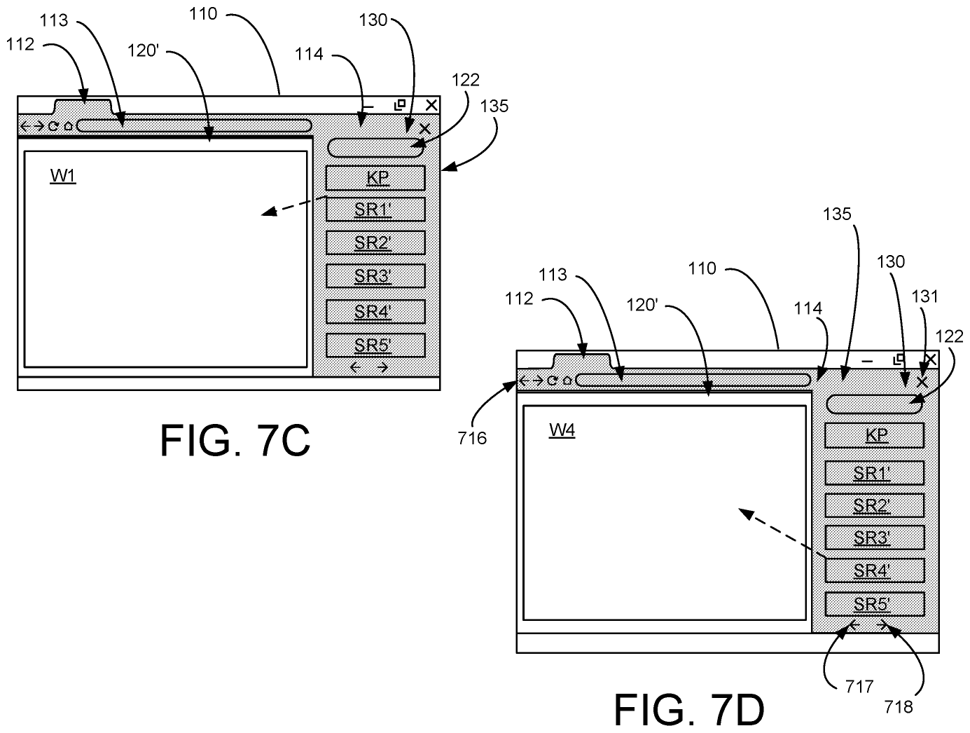

The location and/or shape of the search result area 130 can be different than shown in FIGS. 1B through 1D. In some implementations, the search result area 130 can be smaller in size than shown. In some implementations, the search result area 130 can be included along a different side of the browser 110 (e.g., along a bottom portion, along a top portion, along the left side, and/or so forth). For example, the search result area 130 can be at a bottom location within the browser 110, can be above the address bar area 114, can be on a side of the browser 110 (e.g., as illustrated in FIG. 7C and 7D), and/or so forth. In some implementations, the search result area 130 can float above (e.g., can be rendered in a window above) the display area 120 so that the display area 120 in FIG. 1A is not decreased in size to the area of the display area 120′ shown in FIG. 1B. In some implementations, the search result area 130 can be a different shape (e.g., a circular shape) rather than a square or rectangular shape. As shown in FIGS. 1B through 1D, the search result indicators SR1′ through SR3′ are arranged horizontally within the search result area 130 and can be navigated along a horizontal direction. In some implementations, the search result indicators SR1′ through SR3′ can be arranged within the search result area 130 in a different orientation (e.g., vertically and navigated along a vertical direction).

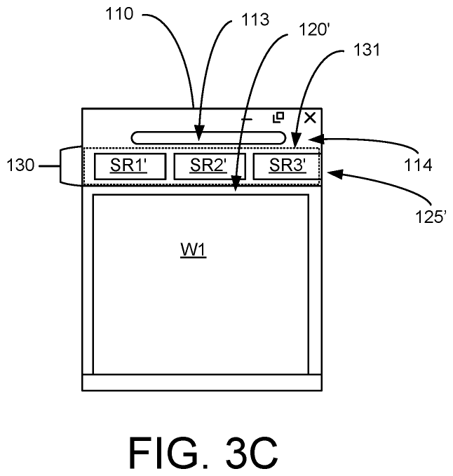

In the implementation shown in FIGS. 3A through 3C, rendering of the search result area 130 is triggered in response to one or more interactions with a webpage. In the example of FIGS. 3A through 3C the interaction is detection of a scrolling pattern. A scrolling pattern defines one or more scrolling inputs that meet a criterion or criteria. The criterion can include an attribute of the scrolling input. For example, a criterion in a scrolling pattern can be a scroll down input that has at least a certain velocity, that meets a distance threshold (e.g., halfway through the content, within a specified distance of the end of the content, etc.), etc. A criterion in a scrolling pattern can specify an order of scrolling actions, e.g., a scroll down followed by a scroll up. A scrolling pattern can combine multiple criteria, e.g., a scroll down to at least a particular threshold, followed by a scroll up of high velocity. The scrolling pattern can be device dependent. The scrolling pattern can be, or can partially be, defined by and/or changed by a user, e.g., as part of a user preference.

As shown in FIG. 3A, search results 125 are displayed within the display area 120 of the browser 110, similar to FIG. 1A. In response to selection of the search result SR1, webpage W1 is displayed in display area 120 as shown in FIG. 3B. However, in the example of FIG. 3A, selection of the search result SR1 does not trigger display of the search result area 130. Instead, in the example of FIG. 3A and 3B, the search result area 130 is rendered in response to an interaction with the webpage Wl. In the example of FIG. 3B the interaction is defined by detection of a scroll pattern. In some implementations, the scroll pattern may be detection of a scroll down action, as represented by the arrow A in FIG. 3B. A scroll down action occurs when content not initially displayed is scrolled into view. Although referred to as “down” it is understood that any direction that moves content not initially displayed into view corresponds to a scroll down. A scroll up action is in a direction opposite of a scroll down action. In the example of FIG. 3B, the search result area 130 can be displayed (as illustrated in FIG. 3C) in response to detection of the scroll pattern. A scroll pattern that includes the existence of a scroll down action may represent a user demonstrating interest in the webpage W1 associated with the search result SR1, e.g., by scrolling down to review the content.

In some implementations, scroll pattern may include detection of a scroll down action followed by a scroll up action having a threshold velocity. For example, in such implementations the browser may render the search result area 130 in response to the user demonstrating disinterest in the webpage W1 associated with the search result SR1. Disinterested may be demonstrated by the user scrolling down to view the content followed by a scroll up occurring at a much faster rate, e.g., at least a threshold velocity. This interaction may indicate the user did not find the content satisfactory and the user is likely to return to the search result page and select another search result. In this example, the browser may anticipate the return to the search results page (e.g., via the browser's back control) and may trigger display of search result area 130 automatically. Triggering the search result area 130 in response to a scroll pattern can save the user from navigating back to the search result page and allow the user to navigate through the search results via the search result area 130. In this example, in response to scrolling down (arrow A) within the webpage W1 the search result area 130 may not be rendered until the system detects scrolling back up (arrow B) after scrolling down. Thus, the search result area 130 may be rendered, e.g., as illustrated in FIG. 3C, in response to detecting a scroll pattern of a scroll down action followed by a scroll up action.

As previously discussed, the scroll pattern can also specify attributes of the scroll actions (e.g., the scroll up action and/or the scroll down action). For example, in some implementations, the scroll pattern may trigger display of the search result area 130 when the user has performed a first scroll action (e.g., scrolled down (arrow A)) to a certain threshold (e.g., halfway down the content, 1/3 of the way down the content, etc.) before the performing the second scroll action (e.g., a scroll up (arrow B)) completes the scroll action and triggers display of the search result area 130. In some implementations, the browser may require a scroll speed threshold to be met, e.g., faster scrolling in either direction satisfying the scroll pattern criteria.

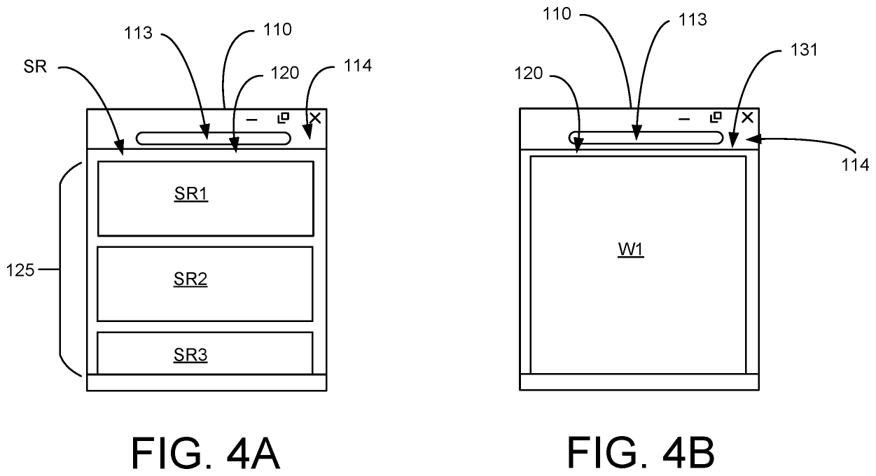

In some implementations, the search result area 130 may be rendered after more than one search result of the search results 125 is selected. This implementation is illustrated in FIGS. 4A through 4D. For example, search results 125 are displayed within the display area 120 of the browser 110 as shown in FIG. 4A, similar to FIG. 1A. In response to selection of the search result SR1, webpage W1 is displayed in display area 120 as shown in FIG. 4B. A user may navigate back (e.g., via selection of a back control) to the search results as shown in FIG. 4C and the user may select the search result SR2. In response to selection of the search result SR2, the search result area 130 and the webpage W2 associated with the search result SR2 may be rendered as shown in FIG. 4D. Accordingly, the search result area 130 can be displayed in response to a user demonstrating interest in additional search results SR. In some implementations, instead of navigating back to the search results as shown in FIG. 4C, the user interaction with the back control while viewing webpage W1 (e.g., in FIG. 4B) may trigger display of the search result area 130 and content of webpage W1 (e.g., similar to FIG. 1B or 3C). Thus, interaction with a back control can trigger display of the search result area 130. In some implementations, the trigger of the search result area 130 also depends on the target of the back control, or in other words, what content /resource is to be displayed as a result of the selection of (interaction with) the back control. If the target is a search result page the browser may, instead of navigating back to the search result page, trigger display of the search result area 130.

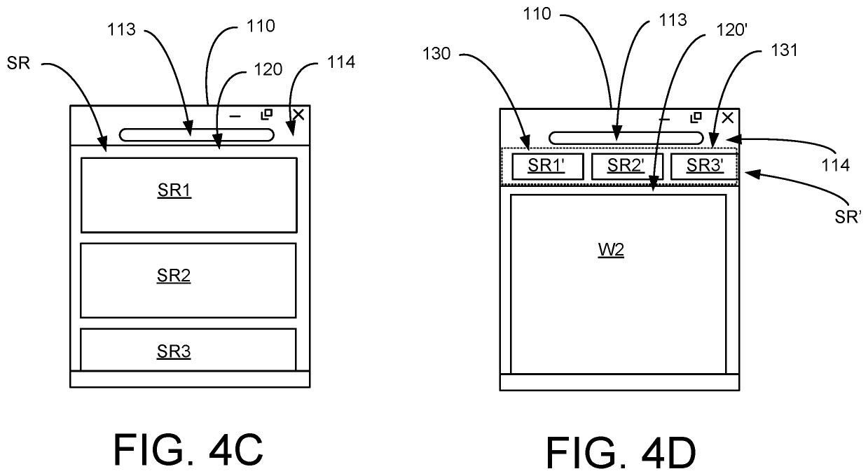

In some implementations, interaction with (e.g., selection of) a link A1 within a webpage W1 while the search result area 130 is shown (as shown in FIG. 5A) can result in the search result area 130 being closed (as shown in FIG. 5B). Put another way, selection of any actionable element within the content displayed in the display area 120′ may trigger removal of the search result area 130. Thus, the webpage WA1, which is associated with the link A1 in FIG. 5A can be rendered within the display area 120. Although not shown, in some implementations, the search result area 130 is not closed in response to interaction with a link Al within the webpage W1 and opening of the webpage WA1.

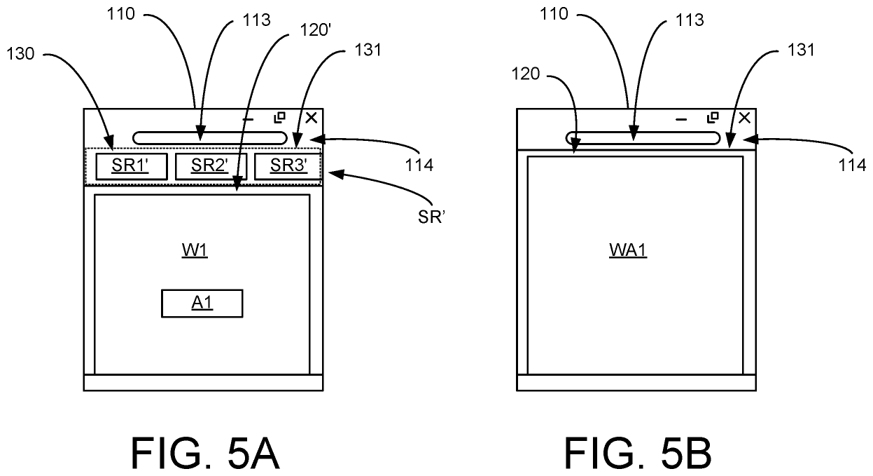

FIG. 6 illustrates a security feature associated with the implementations described herein. As shown in FIG. 6, the address bar area 114 of the browser 110 and the search result area 130 are part of a contiguous area. Put another way, the browser can render the search result area 130 as part of the browser-controlled address bar area 114. This contiguous area (e.g., combined address bar area 114 and search result area 130) can be referred to as a browser search area 135. The browser search area 135 is illustrated in FIG. 6 by the gray color that is contiguous between the address bar area 114 and the search result area 130. This implementation shown and described in connection with FIG. 6 can be combined with any of the implementations described above, for example, in connection with FIGS. 1A through 5B.

The search result area 130 can be integrated as part of the browser 110 (e.g., address bar area 114) as the browser search area 135 so that the search result area 130 may not be spoofed (e.g., imitated) by, for example, a third party or the owner of the content of the webpage W1 content. Because the search result area 130 is part of the application of the browser 110, the integration of the search result area 130 would be difficult to imitate. In some implementations, no clear separation (e.g., no separate line exists between the search result area 130 and the address bar area 114. Because the search result area 130 and the address bar area 114 are contiguous, any background or theme applied to the address bar area 114 would flow into (and would be contiguous with) the search result area 130 (as illustrated by the gray area). The contiguous background would be difficult for a third party (e.g., provider of the webpage W1) to imitate within an application of the browser 110. Moreover, the browser search area 135 can be implemented as a security feature so that a user can distinguish legitimate search results provided by a search engine in response to a query from search results that can be inserted or manipulated by a third party or by the provider of the webpage.

The combining of the search result area 130 and the address bar area 114 can be an indicator of the authenticity of the content in the search result area 130. When the search result area 130 and the address bar area 114 are combined, it signifies that the browser 110 (or provider of the browser 110) is providing the search result indicators 125′ in the search result area 130. In some implementations, when a separating line is present between the search result area 130 and the address bar area 114, results in the search result area 130 may be provided by an untrusted provider (e.g., a third party).

In FIG. 6, the display area 120′ is shown as being adjacent to the browser search area 135 (or a portion thereof). In some implementations, the display area 120′ (as shown in FIG. 1B, for example) can be included in the browser 110 adjacent to the browser search area 135 (or a portion thereof).

FIGS. 7A through 7D illustrate a search result area for a browser executing on a device with a larger screen. The example of FIG. 7A through 7D also illustrates the security feature described in FIG. 6. Because the screen is larger than the screen illustrated in the prior figures, the search result page returned in response to the query 122 can include more search results (e.g., search results SR1 through SR5) and may include additional elements, such as knowledge panel KP, sponsored area SA (e.g., a sponsored link or advertisement), etc. In some implementations, the display area 120 can include an indication of the query 122. In some implementations, the indication of the query 122 is a text entry area where the user can provide a new query (e.g., modifying or overwriting the current query) and trigger a new search. In some implementations, selection of a search result, such as SR1 of FIG. 7A, results in display of webpage W1 in a display area 120 of the browser, as illustrated in FIG. 7B. In the example of FIG. 7A and 7B, the search results 125 and the webpage W1 are opened in the same browser tab, i.e., browser tab 112. This functionality is similar to FIG. 4B. In one implementation, interaction with a back control, e.g., back control 716, triggers the rendering of the search result area 130, as illustrated in FIG. 7C.

The search result area 130 of FIG. 7C is contiguous with address bar area 114. Thus, as in FIG. 6, the search result area 130 and the address bar area 114 are referred to as browser search area 135. Because the screen of FIG. 7C is larger than that of FIG. 6, the search result area 130 is larger. Thus, in some implementations, the search result indicators 125′ (i.e., SR1′ through SR5′) can be the same as or substantially the same as the search results 125 (i.e., SR1 through SR5). In some implementations, the search result indicators 125′ of FIG. 7C can include a portion of the information from the search results 125 of FIG. 7A. In some implementations, the portion may include text portions but lack image portions. In some implementations the portion can be a title portion. In some implementations the search result indicator may include a title from the search result but lack a snippet from the search result. The search result indicators for the search result area 130 of a screen with larger area (e.g., the screen represented in FIG. 7C) can include less text and/or images than the search results, but more than the search result indicators for a screen with limited area. In some implementations, the search result indicators 125′ may be similar to the informational search result indicators of FIG. 2C. As with the other figures described herein, a search result indicator has the same identification of (link to) a resource that its corresponding search result has and selection of a search result indicator in the search result area 130 causes the browser to display the content of the resource associated with the selected search result in the display area 120′. Thus, for example, selection of SR4 in FIG. 7C causes display of content associated with website W4 in the display area 120′, as illustrated in FIG. 7D. In some implementations, the search result area 130 may include other elements from the search result page, e.g., knowledge panel KP (illustrated in FIG. 7C) and/or sponsored area SA (not illustrated in FIG. 7C). In some implementations, the browser may extract information from the search result page and determine what information to include in the search result area 130. In some implementations, the search server may communicate which elements to include in the search result area to the browser.

In some implementations, the search result area 130 may include search result navigation controls, such as previous control 717 and next control 718. In some implementations, the browser may be configured to ensure that use of the previous control 717 and the next control 718 (or other navigation controls in the search result area 130) do not result in navigation away from the search domain. In some implementations, the search result area 130 may display the identifier (e.g., the URL) from which the content of the search result area 130 is obtained. This may provide an indication that the content of the side panel is not spoofed. In some implementations, the browser may be configured to only communicate with a known search server when a navigation request is initiated in the search result area (requests to view a target of a search result are loaded in the display area 120′ and do not constitute navigation within the search result area 130. In other words, the browser may be configured to only send messages to a known domain for a search engine identified to the browser, e.g., a search configuration in user settings, when the message is triggered by navigation controls interacted with in the search result area 130. In some implementations, the browser may use an address pattern (e.g., a URL pattern) that is specified, e.g., as a search configuration to determine whether navigation occurs in the search result area 130 or the display area 120′. For example, when a requested resource does not match the address pattern navigation occurs in the display area 120′.

In some implementations, similar to FIGS. 1A and 1B, selection of the search result SRI in FIG. 7A can trigger display of the search result area 130 and the content of webpage W1 in the display area 120′, e.g., as illustrated in FIG. 7C. In other words, in some implementations, interaction with a search result on a search result page may trigger display of the search result area 130. In some implementations (not shown), the user may expressly open (trigger display of) the search result area 130. For example, if a user performs an alternate selection (e.g., right-click, long-press, long touch, two finger touch, etc.) on a search result (e.g., SRI of FIG. 7A) the browser may render a menu of actions. The alternate selection can be any gesture or action that is not the default gesture/action for a link. A default gesture/action causes the browser to navigate to (open) the webpage associated with the link in the display area 120. The menu of actions may be a pop-up menu. The menu of actions may include actionable elements for performing various actions using the link associated with the search result. For example, the actions can include opening the webpage W1 in a new browser tab. The actions can include opening the webpage W1 in a new browser instance (also called a new browser window). The actions can include copying the link to a clipboard, sharing the link etc. In some implementations, the actions can include a persistent search action. The persistent search action is an action that causes rendering of the search result area 130 and opening the webpage W1 in the display area 120′. In other words, one of the actions can be a persistent search action that triggers display of the search result area 130 and causes the browser to open the content of the webpage W1, e.g., as illustrated in FIG. 7C.

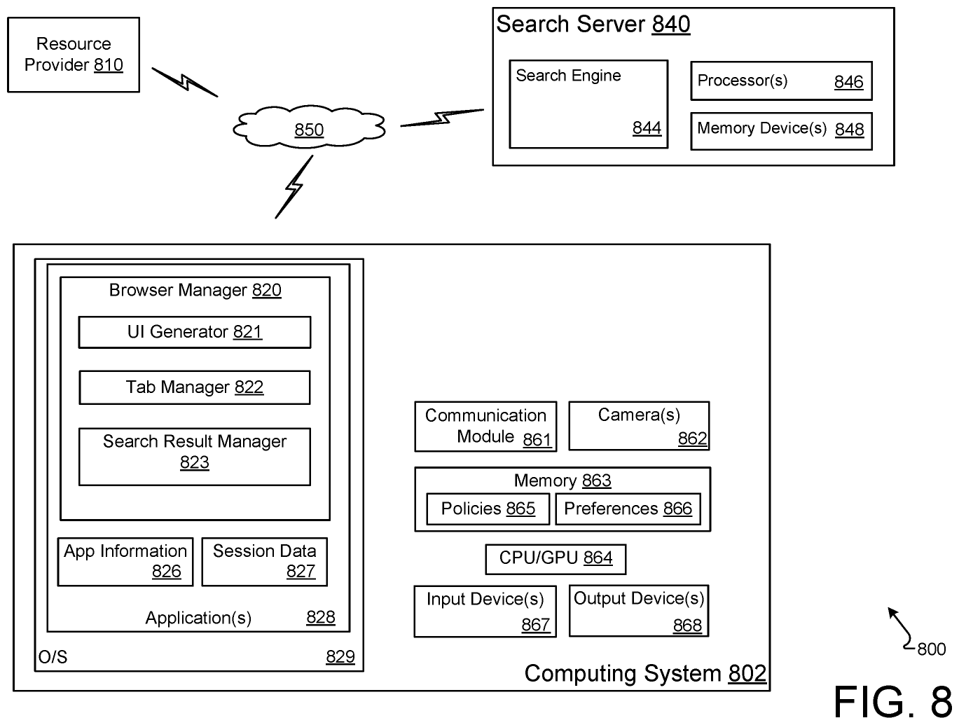

FIG. 8 illustrates a system 800 including a computing system 802 and a search server 840 configured for implementing the concepts and various implementations shown and described herein. The computing system 802 can be a computing device with a limited screen size, such as a smartphone, a smart watch, smart (e.g., A/R or V/R glasses), a tablet, etc. The computing system 802 can be a computing device with a larger screen size, such as a desktop computer, a laptop, a netbook, a notebook, a tablet, a smart TV, a game console with a browser, etc. In general, the computing system 802 can represent any computing device that executes a browser. As shown in FIG. 8, the computing system 802 is configured to communicate with the search server 840 and/or a resource provider 810 (e.g., a web server) via a network 850. The computing system 802 includes at least a browser manager 820 and a search result manager 823. In some implementations, the browser manager 820 is configured to manage resource content, such as webpage content, provided by the resource provider 810 (e.g., a web server). In some implementations, the browser manager 820 is configured to operate as one of several applications 828 executed via an operating system (O/S) 829. The browser manager 820 can be configured to implement portions of the user interface, search results, windows, browser areas, and/or so forth, as described in connection with the implementations described herein.

As shown in FIG. 8, the computing system 802 includes several hardware components including a communication module 861, one or more cameras 862, a memory 863, a central processing unit (CPU) and a graphics processing unit (GPU) 864, one or more input devices 867 (e.g., touch screen, mouse, stylus, microphone, keyboard, etc.), and one or more output devices 868 (screen, speaker, vibrator, light emitter, etc.). The hardware components can be used to facilitate operation of the browser manager 820, the search result manager 823, and/or so forth of the computing system 802.

The browser manager 820 includes a user interface (UI) generator 821 configured to generate and/or manage the various user interface elements of a browser such as browser 110 as shown and described herein. For example, the UI generator 821 can generate UI elements including the various windows in the browser 110 such as the display area 120, the search result area 130, shown in at least FIGS. 1A through 1C, and/or the browser search area 135 shown at least in FIGS. 6 and 7A through 7D.

The browser manager 820 includes a tab manager 822 configured to generate and/or manage the various tabs (e.g., tab 112) of a browser such as browser 110. The browser manager 820 may be configured to, amongst other things, provide/perform the actions associated with actionable controls, such as links in the search results 125 (and search result indicators 125′), back control 716, actionable control 131, previous control 717, and/or next control 718. The tab manager 822 can also be configured to provide the menu of actions and cause performance of an action selected from the menu of actions.

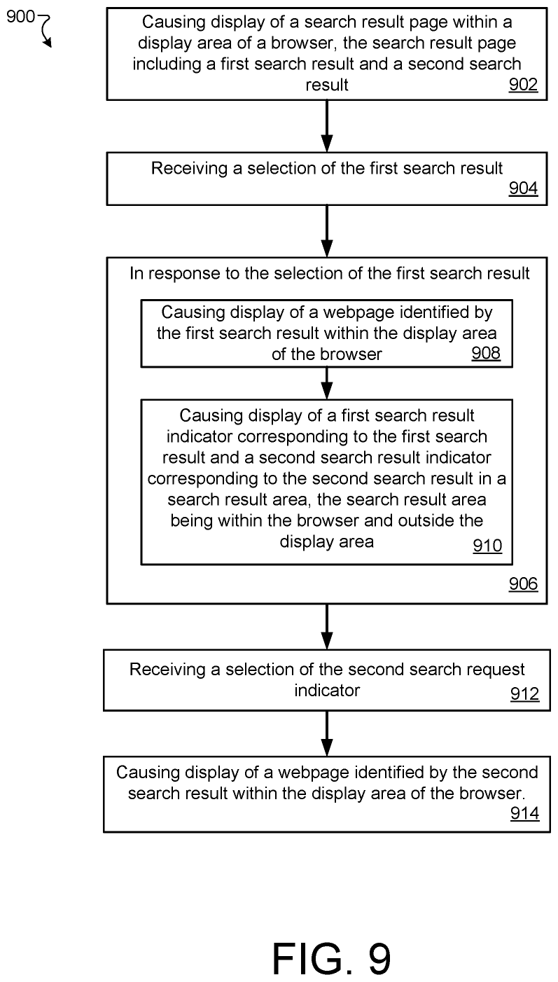

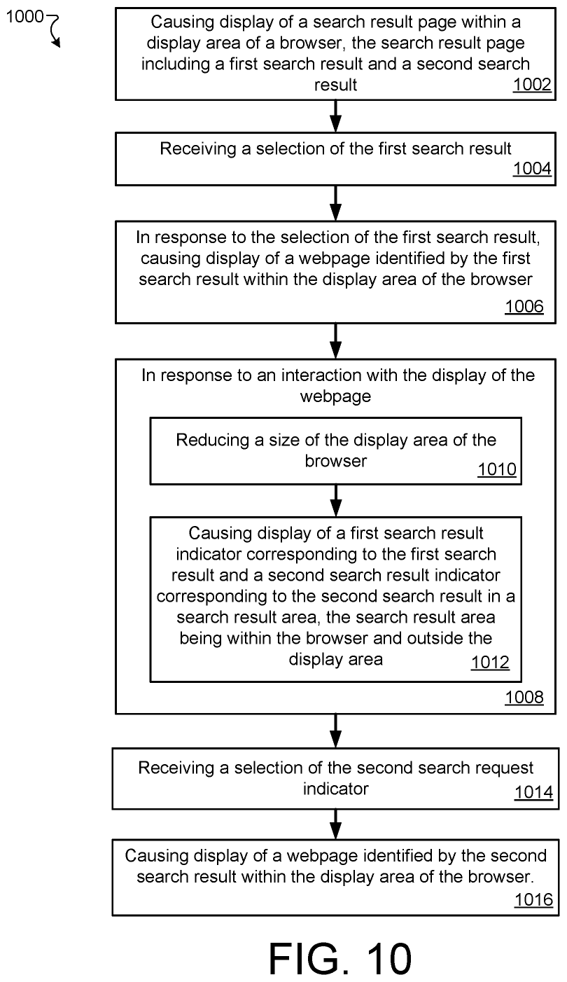

The browser manager 820 includes a search result manager 823 configured to generate and/or manage content rendering such as content in the search result area 130, including the search result indicators 125′ (as shown in at least FIG. 1B, 1C, 2A-2C, 3C, 4D, 6, 7C and other figures). The search result manager 823 can also be configured to determine when to trigger display of the search result area 130. Put another way, the search result manager 823 can be configured to determine what events trigger rendering of the search result area 130 and whether the triggering event has occurred. Triggering events can include any of those discussed herein, such as interaction with a search result on a search result page, selection of an action from a menu of actions, interaction with a resource that was displayed in response to selection of a search result (e.g., certain scrolling patterns, selection of a back control, selection of a back control that has a search result page as the target), etc. The browser manager 820 can be configured to generate and/or manage content rendering associated with a webpage W1 in the display area 120 (including display area 120′), shown in FIGS. 1A, 1B, 7A, 7C, and other figures. The webpage W1 content can be provided to the computing system 802 by the resource provider 810. The browser manager 820 and/or the search result manager 823 can be configured to implement one or both of the processes, or portions of the processes, described in connection with FIGS. 9 and 10.

As shown in FIG. 8, session data 827 (which can be stored in memory 863 (not shown)) can be managed as, or by, one of the applications 828. The session data 827 can include data related to one or more browser sessions. The application information 826 can include information related to the various applications operating within and/or that can be executed by the O/S 829.

As shown in FIG. 8, the communication module 861 can be configured to facilitate communication with the resource provider 810 and/or search server 840 via the network 850 via one or more communication protocols. The camera 862 can be used for capturing one or more images, the memory 863 can be used for storing information associated with the browser manager 820 and/or search result manager 823, other applications 828, O/S 829, etc. The CPU/GPU 864 can be used for processing information and/or images associated with the browser manager 820 and/or search result manager 823. The computing system 802 also includes one or more output devices 868 such as communication ports, speakers, displays, and/or so forth. The functionality described in this application can be implemented based on one or more policies 865 and/or preferences 866 stored in the memory 863.

FIG. 8 illustrates some aspects of the search server 840. For example, the search server 840 includes one or more processors 846 and one or more memory devices 848. The search server 840 includes a search engine 844 configured to receive a request for a search (a query), from the computing system 802. The search engine 844 may be used to provide a search result page for a given query. A query can be a word, a phrase, multiple words, an image, a media file, etc., as is known. The search engine 844 is configured to search one or more data repositories for resources responsive to the query. Specifically, the search engine 844 may use an index of webpages, an index of images, an index of products, an entity repository, a news index, etc., to determine the content of the search result page. The search result page includes one or more search results, where each search result corresponds to a resource responsive to the query. Each search result includes a link to its respective resource. In some implementations, the search engine 844 can add additional elements to the search result page, such as ads, sponsored links, rich elements (knowledge panels, short answers, mini-apps, carousels, navigation links, etc.) to the search result page.

FIG. 9 is a flowchart that illustrates an example method 900 of performing at least some of the concepts described herein in the various figures. Many elements of the method 900 can be implemented by the system shown in at least FIG. 8. In particular, the method 900 can be performed by a browser, (e.g., browser manager 820) of a computing system 802. The example method 900 is an example of triggering display of the search result area (search result area 130) in response to interaction with a search result included in content of a search result page. At step 902, the system may cause display of a search result page within a display area of a browser. The search result page includes search results (i.e., a first search result, a second search result, etc.) that are responsive to a query. The search result page is generated by a search engine in response to the query and returned to the browser that initiated the search request. At step 904, the system may receive a selection of the first search result (e.g., search result SR1 in FIG. 1A and others). Because a search result includes a link to its respective resource, the search result is selectable, or in other words an actionable element.

In response to selection of the first search result (step 906), the system may, at step 908, cause display of a webpage (or other resource) identified by the first search result. The resource identified by the search result, e.g., as the target of the link of the search result, is referred to as the search result target. The system causes display of the webpage in a display area of the browser. In addition to causing display of the webpage in the display area, at step 910 the system causes display of a first search result indicator and a second search result indicator in a search result area of the browser. The search result area is displayed concurrently with the display area. In other words, the content of the search result area (e.g., the first search result indicator and the second search result indicator) is visible with the content of the display area (e.g., the content of the webpage). The search result indicators each correspond to a respective search result in the search result page. In other words, the first search result indicator corresponds to the first search result, the second search result indicator corresponds to the second search result, etc. The correspondence means that selection of the first search result indicator causes display of the same resource (e.g., webpage) that selection of the first result causes.

At step 912, the system may receive a selection of the second search request indicator. In response to the selection of the second search request indicator, at step 914, the system causes display of the webpage identified by (corresponding to) the second search result identifier in the display area. The display of the webpage corresponding to the second search result identifier occurs without navigating away from the search result area 130. Thus, the user is able to navigate through the search results (represented by the search result indicators) more efficiently (with fewer interactions with the browser) and with fewer rendering tasks performed by the browser (e.g., because the search results do not need to be re-rendered to select a different search result target).

FIG. 10 is a flowchart that illustrates an example method 1000 of performing at least some of the concepts described herein in the various figures. Many elements of the method 1000 can be implemented by the system shown in at least FIG. 8. In particular, the method 1000 can be performed by a browser, (e.g., browser manager 820) of a computing system 802. The example method 1000 is an example of triggering display of the search result area (search result area 130) in response to interaction with a search result target. At step 1002, the system may cause display of a search result page within a display area of a browser. The search result page includes search results (i.e., a first search result, a second search result, etc.) that are responsive to a query. The search result page is generated by a search engine in response to the query and returned to the browser that initiated the search request. At step 1004, the system may receive a selection of the first search result (e.g., search result SRI in FIG. 7A and others). Because a search result includes a link to its respective resource (it's target), the search result is selectable, or in other words an actionable element. In response to selection of the first search result, at step 1006 the system causes display of the resource (e.g., webpage) identified by the first search result (i.e., the target resource) within the display area of the browser.

The system may receive an interaction with the display of the resource. In some implementations, the interaction can be selection of a back control. The back control is a control configured to, when interacted with (e.g., when selected), cause the browser to render content for a resource that was displayed immediately prior to the current resource. In the example of method 1000, this is the search result page that includes the first search result and the second search result. Some implementations may determine that the prior resource is a search result page (i.e., the back control target is a search result page) and change the default behavior. For example, when the back control target is a search result page, instead of re-rendering the search result page in the display area, the system may instead trigger display of the search result area. The search result area includes search result indicators corresponding to search results of the back control target (i.e., the search result page). In some implementations, the search result page is cached. In some implementations, the search result page is re-fetched (re-requested) from the search server. In some implementations, the interaction can be identification of a scroll pattern that triggers display of the search result area. Scroll patterns are discussed in more detail with respect to FIGS. 3A to 3C.

In response to the interaction (step 1008), trigger display of the search result display area. Triggering display of the search result display area in response to interaction with the webpage can include, at step 1010, decreasing a size of the display area of the browser. This reduction in size makes room for the search result area. As discussed above, in some implementations, the reduction in size may make less content of the webpage visible. In some implementations, the reduction in size may cause the content of the webpage to be resized, or in other words the content of the webpage can also be resized. At step 1012, the system may cause display of the search result area, which includes a first search result indicator and a second search result indicator. The first search result indicator corresponds to the first search result (e.g., that was displayed as part of the search result page. The second search result indicator corresponds to the second search result. The search result area is displayed within the browser but outside of the display area.

At step 1014, the system may receive a selection of the second search request indicator. In response to the selection of the second search request indicator, at step 1016, the system causes display of the webpage identified by (corresponding to) the second search result identifier in the display area. The display of the webpage corresponding to the second search result identifier occurs without navigating away from the search result area. Thus, the user is able to navigate through the search results (represented by the search result indicators) more efficiently (with fewer interactions with the browser) and with fewer rendering tasks performed by the browser (e.g., because the search results do not need to be re-rendered to select a different search result target). In some implementations, the search result area can be removed in response to an express action to close the search result area (e.g., selection of actionable control 131), in response to selection of a link in the display area that causes the browser to navigate to (display) another resource in the display area etc.

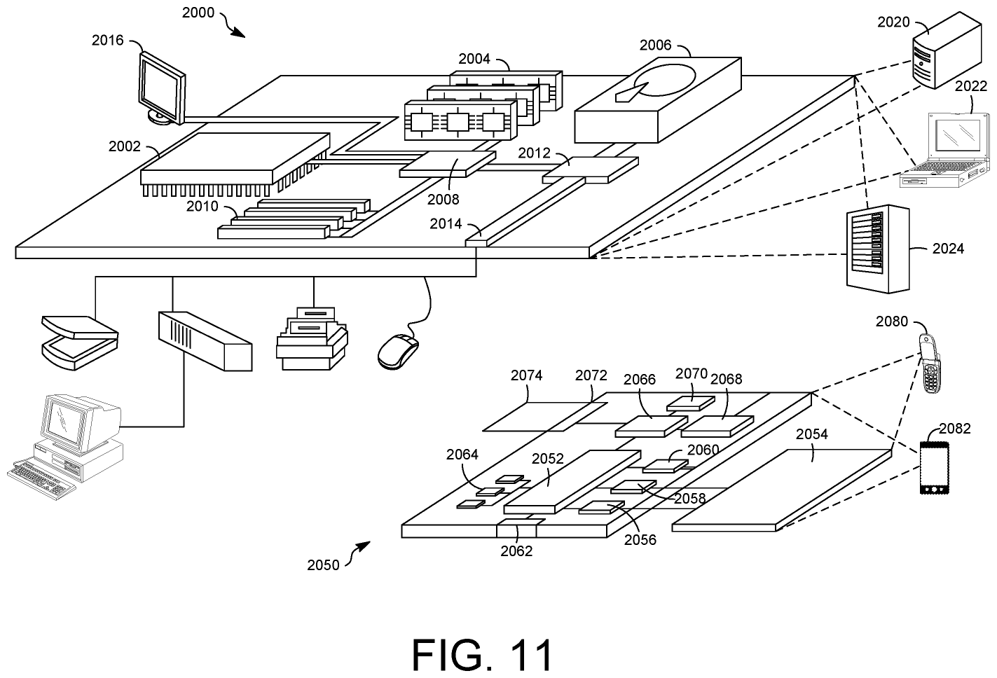

FIG. 11 shows an example of a generic computer device 2000 and a generic mobile computer device 2050, which may be used with the techniques described herein. Computing device 2000 is intended to represent various forms of digital computers, such as laptops, desktops, tablets, workstations, personal digital assistants, televisions, servers, blade servers, mainframes, and other appropriate computing devices. Computing device 2050 is intended to represent various forms of mobile devices, such as personal digital assistants, cellular telephones, smart phones, and other similar computing devices. The components shown here, their connections and relationships, and their functions, are meant to be examples only, and are not meant to limit implementations of the implementations described and/or claimed in this document.

Computing device 2000 includes a processor 2002, memory 2004, a storage device 2006, a high-speed controller 2008 connecting to memory 2004 and high-speed expansion ports 2010, and a low-speed controller 2012 connecting to low speed expansion port 2014 and storage device 2006. The processor 2002 can be a semiconductor-based processor. The memory 2004 can be a semiconductor-based memory. Each of the components 2002, 2004, 2006, 2008, 2010, and 2012, are interconnected using various busses, and may be mounted on a common motherboard or in other manners as appropriate. The processor 2002 can process instructions for execution within the computing device 2000, including instructions stored in the memory 2004 or on the storage device 2006 to display graphical information for a GUI on an external input/output device, such as display 2016 coupled to high-speed controller 2008. In other implementations, multiple processors and/or multiple buses may be used, as appropriate, along with multiple memories and types of memory. Also, multiple computing devices 2000 may be connected, with each device providing portions of the necessary operations (e.g., as a server bank, a group of blade servers, or a multi-processor system).

The memory 2004 stores information within the computing device 2000. In one implementation, the memory 2004 is a volatile memory unit or units. In another implementation, the memory 2004 is a non-volatile memory unit or units. The memory 2004 may also be another form of computer-readable medium, such as a magnetic or optical disk.

The storage device 2006 is capable of providing mass storage for the computing device 2000. In one implementation, the storage device 2006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 2004, the storage device 2006, or memory on processor 2002.

The high-speed controller 2008 manages bandwidth-intensive operations for the computing device 2000, while the low-speed controller 2012 manages lower bandwidth-intensive operations. Such allocation of functions is an example only. In one implementation, the high-speed controller 2008 is coupled to memory 2004, display 2016 (e.g., through a graphics processor or accelerator), and to high-speed expansion ports 2010, which may accept various expansion cards (not shown). In the implementation, low-speed controller 2012 is coupled to storage device 2006 and low speed expansion port 2014. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 2000 may be implemented in a number of different forms, as shown in the figure. For example, it may be implemented as a standard server 2020, or multiple times in a group of such servers. It may also be implemented as part of a rack server system 2024. In addition, it may be implemented in a personal computer such as a laptop computer 2022. Alternatively, components from computing device 2000 may be combined with other components in a mobile device (not shown), such as device 2050. Each of such devices may contain one or more of computing device 2000, 2050, and an entire system may be made up of multiple computing devices 2000, 2050 communicating with each other.

Computing device 2050 includes a processor 2052, memory 2064, an input/output device such as a display 2054, a communication interface 2066, and a transceiver 2068, among other components. The device 2050 may also be provided with a storage device, such as a microdrive or other device, to provide additional storage. Each of the components 2052, 2064, 2054, 2066, and 2068, are interconnected using various buses, and several of the components may be mounted on a common motherboard or in other manners as appropriate.

The processor 2052 can execute instructions within the computing device 2050, including instructions stored in the memory 2064. The processor may be implemented as a chipset of chips that include separate and multiple analog and digital processors. The processor may provide, for example, for coordination of the other components of the device 2050, such as control of user interfaces, applications run by device 2050, and wireless communication by device 2050.

Processor 2052 may communicate with a user through control interface 2058 and display interface 2056 coupled to a display 2054. The display 2054 may be, for example, a TFT LCD (Thin-Film-Transistor Liquid Crystal Display) or an OLED (Organic Light Emitting Diode) display, or other appropriate display technology. The display interface 2056 may comprise appropriate circuitry for driving the display 2054 to present graphical and other information to a user. The control interface 2058 may receive commands from a user and convert them for submission to the processor 2052. In addition, an external interface 2062 may be provide in communication with processor 2052, so as to enable near area communication of device 2050 with other devices. External interface 2062 may provide, for example, for wired communication in some implementations, or for wireless communication in other implementations, and multiple interfaces may also be used.

The memory 2064 stores information within the computing device 2050. The memory 2064 can be implemented as one or more of a computer-readable medium or media, a volatile memory unit or units, or a non-volatile memory unit or units. Expansion memory 2074 may also be provided and connected to device 2050 through expansion interface 2072, which may include, for example, a SIMM (Single In Line Memory Module) card interface. Such expansion memory 2074 may provide extra storage space for device 2050, or may also store applications or other information for device 2050. Specifically, expansion memory 2074 may include instructions to carry out or supplement the processes described above, and may include secure information also. Thus, for example, expansion memory 2074 may be provided as a security module for device 2050, and may be programmed with instructions that permit secure use of device 2050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 2064, expansion memory 2074, or memory on processor 2052, that may be received, for example, over transceiver 2068 or external interface 2062.

Device 2050 may communicate wirelessly through communication interface 2066, which may include digital signal processing circuitry where necessary. Communication interface 2066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 2068. In addition, short-range communication may occur, such as using a Bluetooth, WiFi, or other such transceiver (not shown). In addition, GPS (Global Positioning System) receiver module 2070 may provide additional navigation- and location-related wireless data to device 2050, which may be used as appropriate by applications running on device 2050.

Device 2050 may also communicate audibly using audio codec 2060, which may receive spoken information from a user and convert it to usable digital information. Audio codec 2060 may likewise generate audible sound for a user, such as through a speaker, e.g., in a handset of device 2050. Such sound may include sound from voice telephone calls, may include recorded sound (e.g., voice messages, music files, etc.) and may also include sound generated by applications operating on device 2050.

The computing device 2050 may be implemented in a number of different forms, as shown in the figure. For example, it may be implemented as a cellular telephone 2080. It may also be implemented as part of a smart phone 2082, tablet, glasses, smart watch, personal digital assistant, or other similar mobile device.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described herein), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

A number of implementations have been described. Nevertheless, it will be understood that various modifications may be made without departing from the spirit and scope of the disclosed implementations.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

In some aspects, the techniques described herein relate to a method, including: receiving a search query; causing display of a first search result and a second search result within a display area of a browser in response to the search query; and in response to a selection of the first search result: causing display of a webpage within the display area of the browser, the webpage being identified by the first search result; and causing display of a first search result indicator corresponding with the first search result and a second search result indicator corresponding with the second search result in a search result area outside of the display area, the search result area being within the browser.

In some aspects, the techniques described herein relate to a method, further including: receiving a selection of the second search result indicator; and causing display of a webpage identified by the second search result within the display area of the browser in response to the selection of the second search result indicator.

In some aspects, the techniques described herein relate to a method, wherein causing the display of the webpage identified by the second search result within the display area replaces the webpage identified by the first search result and the second search result indicator shifts position within the search result area.

In some aspects, the techniques described herein relate to a method, wherein the display area is decreased in size to accommodate display of the search result area.

In some aspects, the techniques described herein relate to a method, wherein the selection of the first search result is an alternate selection and the method includes: rendering a menu of actions for the first search result, the menu including a persistent search action; receiving selection of the persistent search action; and in response to receiving the selection of the persistent search action, causing display of the webpage within the display area and causing the display of the search result area.

In some aspects, the techniques described herein relate to a method, further including: receiving selection of a link in the webpage; and responsive to receiving selection of the link: removing the search result area, and causing display of a resource identified by the link in the display area.

In some aspects, the techniques described herein relate to a method, further including: receiving a first selection of a back control; causing display of the webpage in the display area; receiving a second selection of the back control; and responsive to receiving the second selection of the back control causing display of the search result area with the first search result indicator and the second search result indicator concurrently with display of the webpage in the display area.

In some aspects, the techniques described herein relate to a method, wherein the first search result includes a snippet and the first search result indicator lacks the snippet.

In some aspects, the techniques described herein relate to a method, wherein the search result area is part of a browser search area.

In some aspects, the techniques described herein relate to a method, including: causing display of a first search result and a second search result within a display area of a browser in response to a query; receiving selection of the first search result; in response to the selection of the first search result, causing display of a webpage within the display area of the browser; receiving an interaction with the display of the webpage; and in response to the interaction with the display of the webpage, causing display of a first search result indicator corresponding with the first search result and a second search result indicator with the second search result in a search result area outside of the display area, the search result area being within the browser.

In some aspects, the techniques described herein relate to a method, wherein the interaction is selection of a back control selected during display of the webpage in the display area.

In some aspects, the techniques described herein relate to a method, wherein the interaction is a scroll pattern.

In some aspects, the techniques described herein relate to a method, wherein the interaction is a scroll pattern identifies a scroll action and an attribute of the scroll action.

In some aspects, the techniques described herein relate to a method, wherein the interaction is a scroll pattern identifies a first scroll action followed by a second scroll action.

In some aspects, the techniques described herein relate to a method, wherein the search result area is part of a browser search area.

In some aspects, the techniques described herein relate to a method, further including: receiving a selection of the second search result indicator; and in response to the selection of the second search result indicator, causing display of a webpage identified by the second search result within the display area of the browser.

In some aspects, the techniques described herein relate to a method, wherein causing the display of the webpage identified by the second search result within the display area replaces the webpage identified by the first search result and the second search result indicator shifts position within the search result area.

In some aspects, the techniques described herein relate to a method, further including: receiving selection of a link in the webpage; and responsive to receiving selection of the link: removing the search result area, and causing display of a resource identified by the link in the display area.

In some aspects, the techniques described herein relate to a system, including at least one processor; and memory storing instructions that, when executed by the at least one processor, causes the system to perform any of the methods or processes disclosed herein.

In some aspects, the techniques described herein relate to a non-transitory computer-readable medium storing instructions, that when executed by a processor, cause a computing system to perform any of the methods or processes disclosed herein.

In some aspects, the techniques described herein relate to a system including a means for triggering display of a search result page in a search result area of a browser and a webpage in a display area of the browser, where the search result area is outside of the display area and the search result area is within the browser. In some implementations, the system may also include a means for navigating the search result page within the search result area.

What is claimed is:

1. A method, comprising:
receiving a search query;
causing display of a first search result and a second search result within a display area of a browser in response to the search query; and
in response to a selection of the first search result:
causing display of a webpage within the display area of the browser, the webpage being identified by the first search result; and
causing display of a first search result indicator corresponding with the first search result and a second search result indicator corresponding with the second search result in a search result area outside of the display area, the search result area being within the browser.

2. The method of claim 1, further comprising:
receiving a selection of the second search result indicator; and
causing display of a webpage identified by the second search result within the display area of the browser in response to the selection of the second search result indicator.

3. The method of claim 2, wherein causing the display of the webpage identified by the second search result within the display area replaces the webpage identified by the first search result and the second search result indicator shifts position within the search result area.

4. The method of claim 1, wherein the display area is decreased in size to accommodate display of the search result area.

5. The method of claim 1, wherein the selection of the first search result is an alternate selection and the method comprises:
rendering a menu of actions for the first search result, the menu including a persistent search action;
receiving selection of the persistent search action; and
in response to receiving the selection of the persistent search action, causing display of the webpage within the display area and causing the display of the search result area.

6. The method of claim 1, further comprising:
receiving selection of a link in the webpage; and
responsive to receiving selection of the link:
removing the search result area, and
causing display of a resource identified by the link in the display area.

7. The method of claim 6, further comprising:
receiving a first selection of a back control;
causing display of the webpage in the display area;
receiving a second selection of the back control; and
responsive to receiving the second selection of the back control causing display of the search result area with the first search result indicator and the second search result indicator concurrently with display of the webpage in the display area.

8. The method of claim 1, wherein the first search result includes a snippet and the first search result indicator lacks the snippet.

9. The method of claim 1, wherein the search result area is part of a browser search area.

10. A method, comprising:
causing display of a first search result and a second search result within a display area of a browser in response to a query;
receiving selection of the first search result;
in response to the selection of the first search result, causing display of a webpage within the display area of the browser;
receiving an interaction with the display of the webpage; and
in response to the interaction with the display of the webpage, causing display of a first search result indicator corresponding with the first search result and a second search result indicator with the second search result in a search result area outside of the display area, the search result area being within the browser.

11. The method of claim 10, wherein the interaction is selection of a back control selected during display of the webpage in the display area.

12. The method of claim 10, wherein the interaction is a scroll pattern.

13. The method of claim 10, wherein the interaction is a scroll pattern identifies a scroll action and an attribute of the scroll action.

14. The method of claim 10, wherein the interaction is a scroll pattern identifies a first scroll action followed by a second scroll action.

15. The method of claim 10, wherein the search result area is part of a browser search area.

16. The method of claim 10, further comprising:
receiving a selection of the second search result indicator; and
in response to the selection of the second search result indicator, causing display of a webpage identified by the second search result within the display area of the browser.

17. The method of claim 16, wherein causing the display of the webpage identified by the second search result within the display area replaces the webpage identified by the first search result and the second search result indicator shifts position within the search result area.

18. The method of claim 16, further comprising:
receiving selection of a link in the webpage; and
responsive to receiving selection of the link:
removing the search result area, and
causing display of a resource identified by the link in the display area.

19. A system, comprising:
at least one processor; and
memory storing instructions that, when executed by the at least one processor, causes the system to perform operations including:
causing display of a first search result and a second search result within a display area of a browser in response to a query;
receiving selection of the first search result;
in response to the selection of the first search result, causing display of a webpage within the display area of the browser;
receiving an interaction with the display of the webpage; and
in response to the interaction with the display of the webpage, causing display of a first search result indicator corresponding with the first search result and a second search result indicator with the second search result in a search result area outside of the display area, the search result area being within the browser.

20. The system of claim 19, wherein the interaction is selection of a back control selected during display of the webpage in the display area.

21. The system of claim 19, wherein the interaction is a scroll pattern.
